(19) United States
(12) Patent Application Publication
(10) Pub. No.: US 2023/0289273 A1
(43) Pub. Date: Sep. 14, 2023

(54) THERMAL THROTTLING SUPRESSION DEVICE, THERMAL THROTTLING SUPRESSION METHOD, AND THERMAL THROTTLING SUPPRESSION PROGRAM

(71) Applicant: Nippon Telegraph and Telephone Corporation, Tokyo (JP)

(72) Inventors: Masashi KANEKO, Musashino-shi, Tokyo (JP); Koichi Hara, Musashino-shi, Tokyo (JP)

(21) Appl. No.: 18/013,832

(22) PCT Filed: Jul. 3, 2020
(86) PCT No.: PCT/JP2020/026137

§ 371 Date: Dec. 29, 2022

(51) Int. Cl. G06F 11/30; G06F 11/34; G06F 9/455

(52) U.S. Cl. CPC G06F 11/3058; G06F 11/3476; G06F 9/45558; G06F 2009/45591

(57) ABSTRACT

A prediction device (2) includes a TT occurrence prediction unit (22) that calculates a TT occurrence rate that is a probability of occurrence of TT for each VM on the basis of a log of VM arrangement data indicating the VM arranged in each server (10) and a log of TT occurrence data indicating TT that has occurred in each server (10), and determines new VM arrangement data such that the TT occurrence rate is smoothed in each server (10), and a VM management unit (21) that arranges the VM in each server (10) according to the new VM arrangement data determined by the TT occurrence prediction unit (22).

### TECHNICAL FIELD

The present invention is a technique of a thermal throttling suppression device, a thermal throttling suppression method, and a thermal throttling suppression program.

### BACKGROUND ART

In a highly reliable system such as a communication system, performance guarantee of the system is important. Patent Literature 1 describes a performance guarantee system of a virtual machine (VM) that guarantees target performance in service provision in consideration of service level agreement (SLA) in the service provision. In this system, by performing priority control of a shared resource to be allocated to a VM in which a service is provided, desired performance can be obtained at all times.

### CITATION LIST

### Patent Literature

Patent Literature 1: JP 2019-159646 A

### SUMMARY OF INVENTION

### Technical Problem

Some of a central processing unit (CPU), a graphics processing unit (GPU), and a storage, which are constituent devices of a computer, are equipped with a function of thermal throttling (TT), and the TT function lowers performance to protect the device when the device reaches a certain temperature or higher. In a virtualization system that accommodates a plurality of VMs in one physical server, it is important not to concentrate VMs that are likely to cause thermal throttling on a specific physical server.

However, it has not been considered what kind of one or more VMs operated on each physical server causes thermal throttling. Therefore, the existing VM resource allocation technique based on an index such as performance cannot avoid performance degradation due to thermal throttling.

Therefore, even if the performance guarantee of Patent Literature 1 is attempted, thermal throttling is likely to occur in a case where access is excessively concentrated on a specific device or in a case where cooling capacity of a specific device is insufficient.

Therefore, a main object of the present invention is to implement resource allocation capable of suppressing occurrence of thermal throttling.

### Solution to Problem

To solve the above problem, a thermal throttling suppression device of the present invention has the following features.

The present invention includes:
a prediction unit configured to calculate a TT occurrence rate that is a probability of occurrence of TT for each VM on a basis of a log of VM arrangement data indicating the VM arranged in each server and a log of TT occurrence data indicating TT that has occurred in the each server, and determine new VM arrangement data such that the TT occurrence rate is smoothed in the each server; and
a management unit configured to arrange the VM in the each server according to the new VM arrangement data determined by the prediction unit.

### Advantageous Effects of Invention

According to the present invention, it is possible to implement resource allocation capable of suppressing occurrence of thermal throttling.

### BRIEF DESCRIPTION OF DRAWINGS

FIG. 1 is a configuration diagram of a virtualization system according to the present embodiment.

FIG. 2 is a table of a VM arrangement data storage unit according to the present embodiment.

FIG. 3 is a table of a TT occurrence data storage unit according to the present embodiment.

FIG. 4 is tables illustrating a calculation process of a prediction device according to the present embodiment.

FIG. 5 is tables that are the tables of FIG. 4 according to the present embodiment to which description portions are added.

FIG. 6 is a hardware configuration diagram of the devices of the virtualization system of FIG. 1 according to the present embodiment.

### DESCRIPTION OF EMBODIMENTS

Hereinafter, an embodiment of the present invention will be described in detail with reference to the drawings.

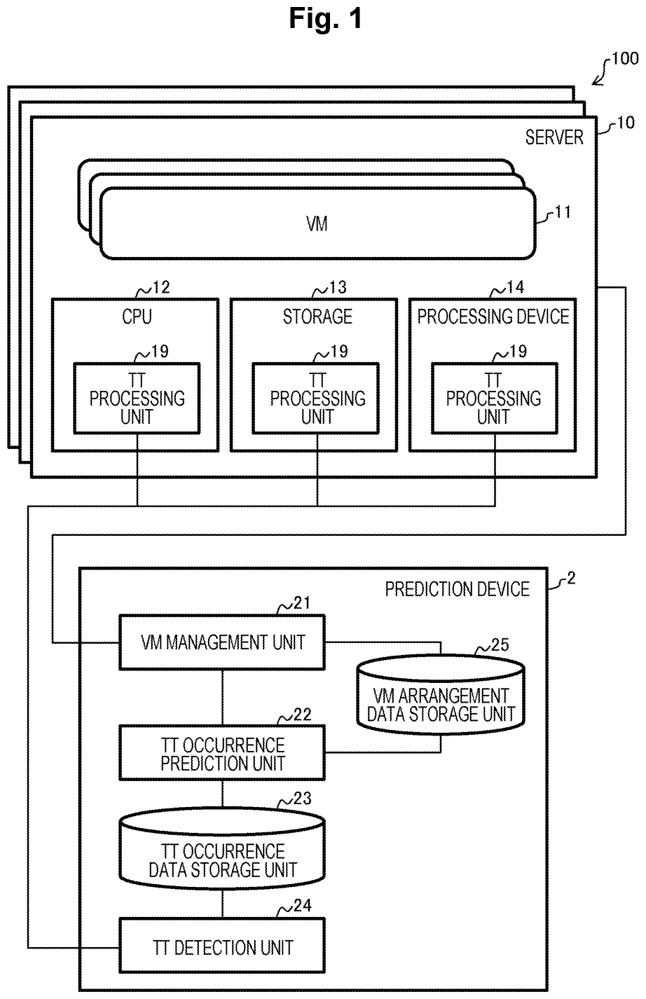

FIG. 1 is a configuration diagram of a virtualization system 100.

The virtualization system 100 is configured by connecting one or more servers 10 and a prediction device (thermal throttling suppression device) 2 via a network.

As physical resources in the server 10, a CPU 12, a storage 13, another processing device 14, and the like are mounted. Each of these physical resources includes a TT processing unit 19 that performs thermal throttling (TT) for preventing overheating of components.

One or more VMs 11 are arranged as a virtual system on the physical resources in the server 10.

The prediction device 2 suppresses occurrence of TT in the server 10 by controlling the arrangement of the VMs 11 in the server 10.

Therefore, the prediction device 2 includes a VM management unit (management unit) 21, a VM arrangement data storage unit 25, a TT occurrence prediction unit (prediction unit) 22, a TT occurrence data storage unit 23, and a TT detection unit 24.

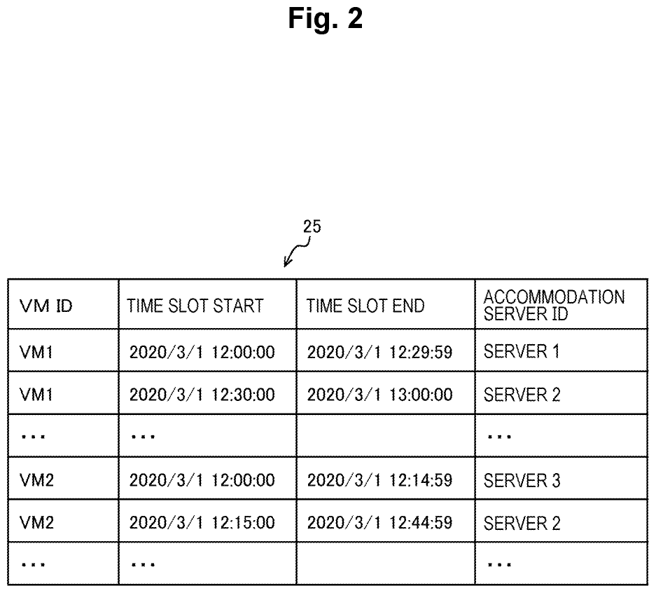

FIG. 2 is a table of the VM arrangement data storage unit 25.

The VM arrangement data storage unit 25 stores, in time series, VM arrangement information indicating to which server 10 each VM 11 is arranged (accommodated). That is, in the VM arrangement data storage unit 25, time slot start and time slot end indicating an accommodation period are associated with an accommodation server ID indicating the server 10 as an accommodation destination for each ID of the VM.

The VM arrangement of the VM arrangement data storage unit 25 is a result of VM arrangement processing by the VM management unit 21.

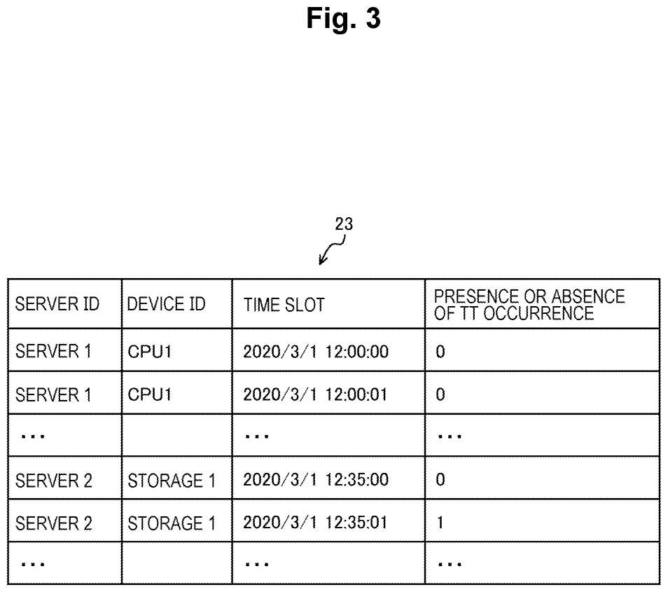

FIG. 3 is a table of the TT occurrence data storage unit 23.

In the TT occurrence data storage unit 23, a physical resource (device ID) indicating a location of TT that has occurred, a time slot at each time, and presence or absence (absence=0/presence=1) of occurrence of TT in the time slot are associated with one another for each server 10.

The TT detection unit 24 detects occurrence of TT in each server 10, and stores a detection result in the TT occurrence data storage unit 23 as time-series log data.

Returning to FIG. 1, description of the processing unit of the prediction device 2 will be continued.

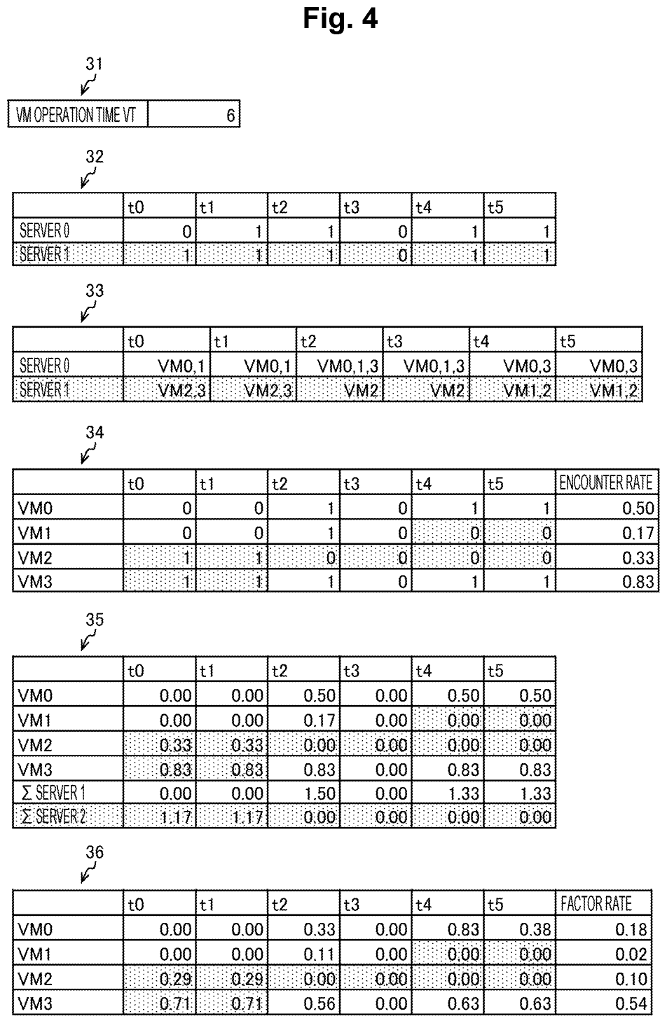

The TT occurrence prediction unit 22 calculates a probability level of occurrence of TT for each VM arrangement combination as a TT occurrence rate from the VM arrangement log data stored in the VM arrangement data storage unit 25 and the TT occurrence log data stored in the TT occurrence data storage unit 23. The TT occurrence rate is embodied as a TT encounter rate TTR [v, p] or a TT factor rate TTC [p, v] to be described below in FIG. 4.

Then, the TT occurrence prediction unit 22 reviews the VM arrangement so that the TT occurrence rates due to the VM arrangement on the plurality of servers 10 are smoothed. Specifically, the smoothing is to individually obtain the TT occurrence rate of each server 10 of the virtualization system 100 and calculate the VM arrangement such that a maximum value of the TT occurrence rates is minimized. Note that the trigger for the TT occurrence prediction unit 22 to review the VM arrangement may be periodic or every time TT occurs.

The VM management unit 21 rearranges the current VM arrangement acquired from the VM arrangement data storage unit 25 (performs arrangement control such as change of the accommodation server) according to a VM arrangement review proposal calculated by the TT occurrence prediction unit 22. The VM management unit 21 writes the rearranged VM arrangement to the VM arrangement data storage unit 25. As a result, the TT occurrence rate of a specific server 10 becomes not excessively higher than those of the other servers 10, and a stable operating state of the servers 10 can be maintained in the entire virtualization system 100.

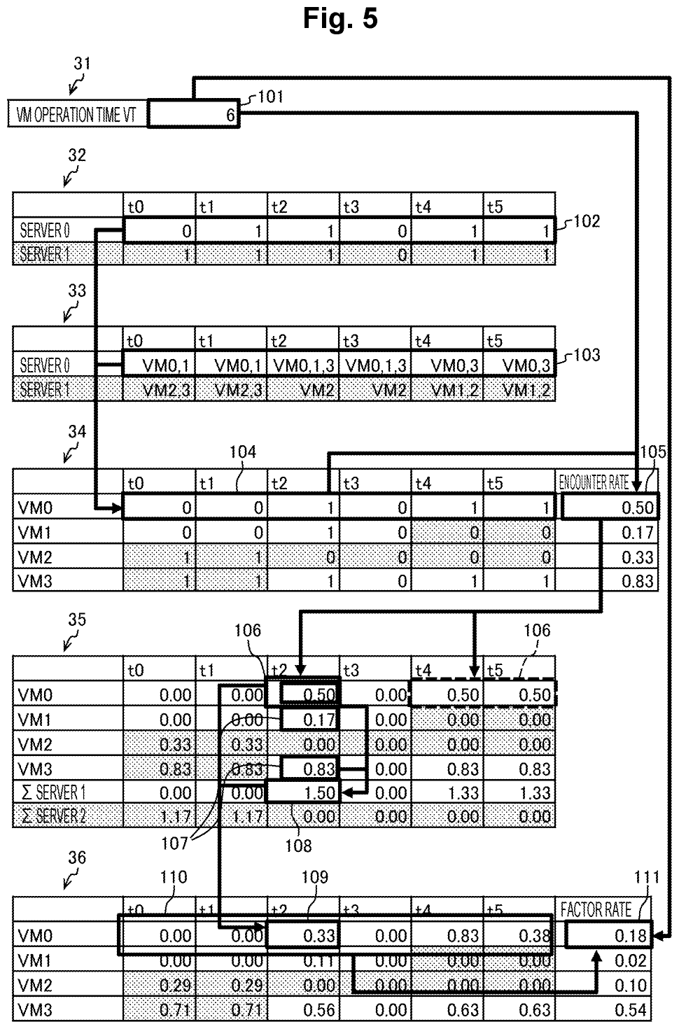

The outline of the virtualization system 100 has been described with reference to FIGS. 1 to 3. Hereinafter, a specific calculation example of the TT occurrence rate will be described with reference to FIGS. 4 and 5.

FIG. 4 is tables illustrating a calculation process of the prediction device 2.

A VM operation period table 31 indicates the number of time slots in which each VM 11 (variable v) operates as a VM operation period VT [v]. The VM operation period VT [v] is a period from a time slot start column to a time slot end column of the VM arrangement data storage unit 25 of FIG. 2. Hereinafter, in FIG. 4, for ease of description, the VM operation periods VT [v] of four VMs 11 (VM 0 to VM 3) are all the same (VT [0]=VT [1]=VT [2]=VT [3]=6).

A TT occurrence log table 32 indicates the presence or absence of occurrence of TT at time t on the physical resource (variable p) of the server 10 (variable s) as a TT occurrence log TT [s, p, t]. TT occurs when TT [s, p, t]=1, and TT does not occur when TT [s, p, t]=0. Further, a background color of a cell in each table including the TT occurrence log table 32 represents the server s=0 (no hatching) or the server s=1 (hatched).

The TT occurrence log TT [s, p, t] corresponds to the TT occurrence presence/absence column in the TT occurrence data storage unit 23 of FIG. 3.

A VM arrangement table 33 indicates a set of VMs arranged on the server (variable s) at time t as a VM arrangement set VS [s, t]. For example, two VMs 11 (VM 0 and VM 1) have been operating on the server (s=0) until time t1, but a new VM 11 (VM 3) is added to the same server (s=0) and starts operating at time t2.

A TT encounter log table 34 indicates whether each VM 11 (variable v) has encountered TT of the physical resource (variable p) at time t as a TT encounter log TTO [v, t, p] (=1 represents encountered, and =0 represents not encountered).

Further, in the re-right column of the TT encounter log table 34, a rate at which each VM 11 (variable v) has encountered TT in all the VM operation periods VT [v] (a probability of taking a value of 0 to 1) is set as the TT encounter rate TTR [v, p].

The first row “VM 0” to the fourth row “VM 3” of a TT encounter rate table 35 are obtained by copying the cell values of the TT encounter rate TTR [v=0, p] of the TT encounter log table 34 for the cell with the value=1 of the TT encounter log table 34.

The fifth row “Σ server 1” and the sixth row “Σ server 2” of the TT encounter rate table 35 will be described below with reference to FIG. 5.

Each time of columns “t0 to t5” of a TT factor rate table 36 indicates a level of possibility that the processing executed by the VM 11 (variable v) has become a factor of the TT that has occurred in the physical resource (variable p) of the server 10 (variable s) at time (variable t), as a TT factor rate by time TTCt [s, p, t, v].

The re-right column “factor rate” of the TT factor rate table 36 indicates a result of normalizing the TT factor rate by time TTCt [s, p, t, v] with the VM operation period VT [v], as the TT factor rate TTC [p, v].

FIG. 5 is tables that are the tables in FIG. 4 to which reference numerals 101 to 111 indicating description portions are added.

As illustrated by reference numeral 101, all the VM operation periods VT [v] of the four VMs 11 (VM 0 to VM 3) are the same (VT [0]=VT [1]=VT [2]=VT [3]=6) as described in FIG. 4. As illustrated by reference numeral 102, all the four VMs 11 take the same value in the TT occurrence log TT [s, p, t] for simplification of description.

The TT occurrence prediction unit 22 obtains the TT encounter log TTO [v=0, t, p] of reference numeral 104 from the TT occurrence log TT [s, p, t] of reference numeral 102 and the VM arrangement set VS [s=0, t] of reference numeral 103.

Then, the TT occurrence prediction unit 22 normalizes the TT encounter log TTO [v=0, t, p] of reference numeral 104 with the VM operation period VT [v] of reference numeral 101 to obtain the TT encounter rate TTR [v=0, p] of reference numeral 105. Specifically, TTR [v, p]=ΣTTO [v, t, p]/VT [v]=(0+0+1+0+1+1)÷6=0.50.

In this way, by performing normalization with the VM operation period, it is possible to compare the VM having a long operation period with the VM having a short operation period on an equal basis.

Note that, in a case where there is a VM that is likely to cause TT, the values of the TT encounter rate of the other VMs existing in the same server also increase. Therefore, there is a case where the value of a VM that is not originally a factor of TT becomes also a high numerical value in a case where the VM is arranged in the same server as the VM that has accidentally caused TT. Therefore, instead of the TT encounter rate TTR [v=0, p], the TT factor rate TTC [p, v] to be described below may be used as the TT occurrence rate.

Reference numeral 106 is obtained by copying the cell values of the TT encounter rate TTR [v=0, p] of reference numeral 105 to the TT encounter rate table 35 for the cells with the value=1 of reference numeral 104. Hereinafter, description will be given focusing on VM 0 (v=0) at time t2.

Note that a set of VMs (here, VM 1 and VM 3 in addition to VM 0 according to reference numeral 103) coexisting (living together) on the same server (s=0) at the same time (t=2) as the VM 0 of interest (v=0) is set as a coexisting VM set VP [v, t] (reference numeral 107).

The fifth row “Σ server 1” of the TT encounter rate table 35 is a sum (0.50+0.17+0.83=1.50) of the cell values of the coexisting VM set VP [v, t] of s=0 (no background hatching) among the cell values of the first to fourth rows (reference numeral 108).

The TT occurrence prediction unit 22 calculates the TT factor rate table 36 from the TT encounter rate table 35 according to the following expression. Note that v′ is VM of interest (v=0).

TTCt [s, p, t, v]=TTR [v, p]/Σ{VP [v, t] [symbol] v′} TTR [v′, p]=(“0.50” of reference numeral 106)/(“1.50” of reference numeral 108)=(“0.33” of reference numeral 109)

With the expression, the TT occurrence prediction unit 22 weights the occurrence factor of TT (“1.50” of reference numeral 108) that has occurred at time t2 in server 0 as a ratio of VM 0 of interest to each of VM 0, VM 1, and VM 3 belonging to the coexisting VM set VP [v, t]. That is, the TT occurrence prediction unit 22 weights the value of the TT encounter rate TTR for each of the VM having a high possibility of becoming a factor of TT and the VM having a low possibility of becoming a factor of TT at the time of occurrence of TT.

Then, the TT occurrence prediction unit 22 calculates the TT factor rate TTC [p, v] for the component device p during the operation period of the VM by the following expression.

TTC [p, v]=Σ{VT [v] [symbol] t}TTCt [s, p, t, v]/VT [v]=(“0.00+0.00+0.33+0.00+0.83+0.38” of reference numeral 110)/(“6” of reference numeral 101)=“0.18” of reference numeral 111

As a result, by normalizing the TT factor rate by time TTCt [s, p, t, v] with the VM operation period VT [v], it is possible to compare the VM having a long operation period with the VM having a short operation period on an equal basis.

The TT occurrence prediction unit 22 newly creates or changes the VM arrangement such that the TT occurrence rates are smoothed in the entire virtualization system 100 (for example, the maximum value of the sum of the TT occurrence rates for each server is minimized) on the basis of the TT encounter rate TTR [v=0, p] of reference numeral 105 or the TT factor rate TTC [p, v] of reference numeral 111. Hereinafter, the VM arrangement combination in which VM 0, VM 1, and VM 2 are arranged in the server s=0 and VM 3 is arranged in the server s=1 is optimal.

[Case of setting the TT encounter rate TTR as the TT occurrence rate] The maximum value (=1) of the sum (0.50+0.17+0.33=1) of the TT encounter rates TTR of the server s=0 and the sum (0.83) of the TT encounter rates TTR of the server s=1 is smallest in all the VM arrangement combinations.

[Case of setting the TT factor rate TTC as the TT occurrence rate] The maximum value (=0.54) of the sum (0.18+0.02+0.10=0.3) of the TT encounter rates TTR of the server s=0 and the sum (0.54) of the TT encounter rates TTR of the server s=1 is smallest in all the VM arrangement combinations.

The VM management unit 21 reflects the calculation result of the VM arrangement of the TT occurrence prediction unit 22 in the arrangement of the VMs 11 of each server 10.

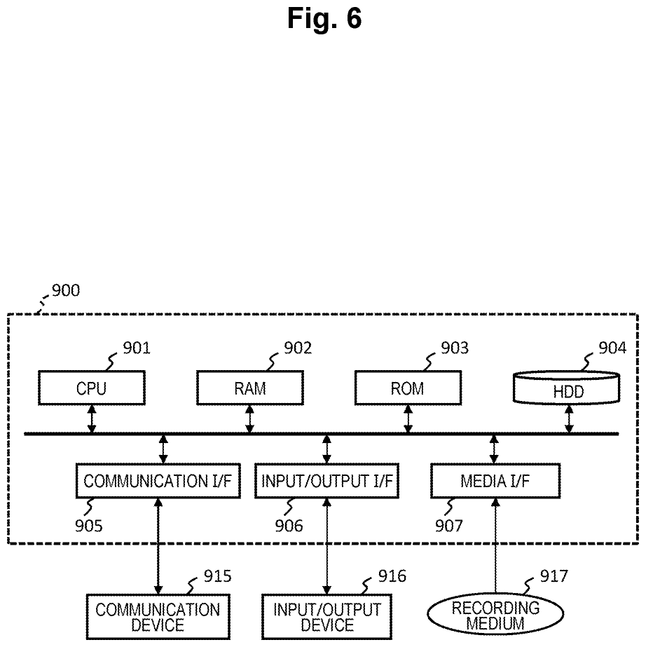

FIG. 6 is a hardware configuration diagram of the devices of the virtualization system 100 of FIG. 1.

Each of the devices (server 10 and prediction device 2) of the virtualization system 100 is configured as a computer 900 including a CPU 901, a RAM 902, a ROM 903, an HDD 904, a communication I/F 905, an input/output I/F 906, and a media I/F 907.

The communication I/F 905 is connected to an external communication device 915. The input/output I/F 906 is connected to an input/output device 916. The media I/F 907 reads and writes data from and to a recording medium 917. Moreover, the CPU 901 controls each processing unit by executing a program (also referred to as an application or an app for short thereof) read into the RAM 902. Then, the program can be distributed via a communication line or recorded in a recording medium 917 such as a CD-ROM and distributed.

### Effects

The present invention includes:
the TT occurrence prediction unit 22 that calculates the TT occurrence rate that is a probability of occurrence of TT for each VM on the basis of the log of VM arrangement data indicating the VM arranged in each server 10 and the log of TT occurrence data indicating TT that has occurred in each server 10, and determines new VM arrangement data such that the TT occurrence rate is smoothed in each server 10; and
the VM management unit 21 that arranges the VM in each server 10 according to the new VM arrangement data determined by the TT occurrence prediction unit 22.

As a result, the VM that is likely to cause TT (the VM having a high load on the specific configuration device) is not concentrated on the specific server 10, so that the following effects can be obtained.
In a system that requires stability of performance, it is possible to avoid unexpected performance deterioration due to occurrence of TT.
By suppressing occurrence of an excessively high temperature state in which TT occurs, device life of the server 10 can be extended.

Meanwhile, as a comparative example, a method of performing load distribution such that a sum of logs of load values for each VM is minimized is considered. In this method, the load value of the log to be referred to is an average value for a certain period, and therefore, the effect of suppressing occurrence of TT caused by a sudden load is small.

The present invention is characterized in that the TT occurrence prediction unit 22 calculates the TT occurrence rate on the basis of the TT encounter rate indicating the degree of a VM that has encountered TT having occurred at predetermined time and in the predetermined server 10 indicated by the log of the TT occurrence data.

As a result, the TT occurrence rate can be calculated even in a black box system in which internal processing of the VM 11 such as what load being applied to the server 10 is unknown.

The present invention is characterized in that the TT occurrence prediction unit 22 calculates the TT occurrence rate on the basis of the TT factor rate obtained by weighting the TT encounter rate indicating the degree of a VM that has encountered TT having occurred at predetermined time and in the predetermined server 10 indicated by the log of the TT occurrence data in relation to another VM that has encountered the same TT.

As a result, only the VM 11 that is likely to cause TT can be calculated to have a high TT occurrence rate by performing weighting suitable for each VM 11 in consideration of an event in which the value of another VM 11 existing in the same server also increases when there is the VM 11 that is likely to cause TT.

### REFERENCE SIGNS LIST

2 Prediction device (thermal throttling suppression device)
10 Server
11 VM
19 TT processing unit
12 CPU
13 Storage
14 Processing device
21 VM management unit (management unit)
25 VM arrangement data storage unit
22 TT occurrence prediction unit (prediction unit)
23 TT occurrence data storage unit
24 TT detection unit
31 VM operation period table
32 TT occurrence log table
33 VM arrangement table
34 TT encounter log table
35 TT encounter rate table
36 TT factor rate table
100 Virtualization system

1. A thermal throttling suppression device comprising:
a prediction unit, including one or more processors, configured to calculate a thermal throttling (TT) occurrence rate that is a probability of occurrence of TT for each virtual machine (VM) on a basis of a log of VM arrangement data indicating the VM arranged in each server and a log of TT occurrence data indicating TT that has occurred in the each server, and determine new VM arrangement data such that the TT occurrence rate is smoothed in the each server; and
a management unit, including one or more processors, configured to arrange the VM in the each server according to the new VM arrangement data determined by the prediction unit.

2. The thermal throttling suppression device according to claim 1, wherein
the prediction unit is configured to calculate the TT occurrence rate on a basis of a TT encounter rate indicating the degree of a VM that has encountered TT having occurred at predetermined time and in the predetermined server indicated by the log of the TT occurrence data.

3. The thermal throttling suppression device according to claim 1, wherein
the prediction unit is configured to calculate the TT occurrence rate on a basis of a TT factor rate obtained by weighting a TT encounter rate indicating the degree of a VM that has encountered TT having occurred at predetermined time and in the predetermined server indicated by the log of the TT occurrence data in relation to another VM that has encountered the same TT.

4. A thermal throttling suppression method, comprising:
calculating a TT occurrence rate that is a probability of occurrence of TT for each VM on a basis of a log of VM arrangement data indicating the VM arranged in each server and a log of TT occurrence data indicating TT that has occurred in the each server, and determine new VM arrangement data such that the TT occurrence rate is smoothed in the each server, and
arranging the VM in the each server according to the new VM arrangement data determined by the prediction unit.

5. A non-transitory computer-readable storage medium storing a thermal throttling suppression program for causing a computer to perform operations comprising:
calculating a TT occurrence rate that is a probability of occurrence of TT for each VM on a basis of a log of VM arrangement data indicating the VM arranged in each server and a log of TT occurrence data indicating TT that has occurred in the each server, and determine new VM arrangement data such that the TT occurrence rate is smoothed in the each server, and
arranging the VM in the each server according to the new VM arrangement data determined by the prediction unit.

6. The non-transitory computer-readable storage medium according to claim 5, wherein the operations further comprise:
calculating the TT occurrence rate on a basis of a TT encounter rate indicating the degree of a VM that has encountered TT having occurred at predetermined time and in the predetermined server indicated by the log of the TT occurrence data.

7. The non-transitory computer-readable storage medium according to claim 5, wherein the operations further comprise:
calculating the TT occurrence rate on a basis of a TT factor rate obtained by weighting a TT encounter rate indicating the degree of a VM that has encountered TT having occurred at predetermined time and in the predetermined server indicated by the log of the TT occurrence data in relation to another VM that has encountered the same TT.

8. The thermal throttling suppression method according to claim 4, further comprising:
calculating the TT occurrence rate on a basis of a TT encounter rate indicating the degree of a VM that has encountered TT having occurred at predetermined time and in the predetermined server indicated by the log of the TT occurrence data.

9. The thermal throttling suppression method according to claim 4, further comprising:
calculating the TT occurrence rate on a basis of a TT factor rate obtained by weighting a TT encounter rate indicating the degree of a VM that has encountered TT having occurred at predetermined time and in the predetermined server indicated by the log of the TT occurrence data in relation to another VM that has encountered the same TT.
